(19) United States
(12) Patent Application Publication
(10) Pub. No.: US 2024/0193287 A1
(43) Pub. Date: Jun. 13, 2024

(54) Managing Workspaces for Computing Devices

(71) Applicant: SAP SE, Walldorf (DE)

(72) Inventors: Christopher Del Frate, Denver, CO (US); Jennifer Chen, Los Gatos, CA (US); Amit Chokshi, Sugarland, TX (US); Ronghui Zeng, North Reading, MA (US); Fazal Ilahi, Bangalore (IN); Shakeer Kovur, Bangalore (IN); Rajaram B, Bangalore (IN)

(21) Appl. No.: 18/065,502

(22) Filed: Dec. 13, 2022

(51) Int. Cl. G06F 21/62; G06F 21/71

(52) U.S. Cl. CPC G06F 21/6218; G06F 21/71; G06F 2221/2141

(57) ABSTRACT

Some embodiments provide a non-transitory machine-readable medium that stores a program. The program may receive a request to create a workspace in which users can collaborate and a set of values for a set of attributes associated with the workspace. Based on the set of values for the set of attributes, the program may determine a set of users associated with the workspace. The program may assign the set of users to the workspace. The program may generate the workspace, the workspace comprising the set of values for the set of attributes and the set of users.

### BACKGROUND

A risk management information system is a computer information system used to aggregate risk data and facilitate the evaluation of business risks. Risk management information systems can provide solutions in the areas of risk identification, risk assessment, risk control, risk financing, etc. Types of risk data may include risk exposure, protection measures, risk management, etc. Examples of such data include loss-control measures, property values, insurance policies, insurance claims, etc.

### SUMMARY

In some embodiments, the techniques described herein relate to a non-transitory machine-readable medium storing a program executable by at least one processing unit of a device, the program including sets of instructions for: receiving a request to create a workspace in which users can collaborate and a set of values for a set of attributes associated with the workspace: based on the set of values for the set of attributes, determining a set of users associated with the workspace: assigning the set of users to the workspace: and generating the workspace, the workspace including the set of values for the set of attributes and the set of users.

In some embodiments, the techniques described herein relate to a non-transitory machine-readable medium, wherein the set of values for the set of attributes is a first set of values for a first set of attributes, wherein the program further includes sets of instructions for; providing a first set of options for specifying the first set of values for the first set of attributes associated with the workspace upon receiving the first set of values for the first set of attributes associated with the workspace, providing a second set of options for specifying a second set of values for a second set of attributes associated with the workspace.

In some embodiments, the techniques described herein relate to a non-transitory machine-readable medium, wherein determining the set of users associated with the workspace based on the set of values for the set of attributes includes: accessing a set of mappings, each mapping in the set of mappings specifying a user and values for a subset of the set of attributes; and identifying users with values for the subset of the set of attributes that match the set of values for the set of attributes.

In some embodiments, the techniques described herein relate to a non-transitory machine-readable medium, wherein each mapping in the set of mappings further specifies a set of access control privileges for controlling access to the workspace by the user based on a status of the workspace, wherein the program further includes a set of instructions for setting a status of the workspace to a first status.

In some embodiments, the techniques described herein relate to a non-transitory machine-readable medium, wherein the program further includes sets of instructions for; receiving an input from a user in the set of users: and in response to receiving the input, setting the status of the workspace to a second status.

In some embodiments, the techniques described herein relate to a non-transitory machine-readable medium, wherein the subset of the set of attributes specified in each mapping in the set of mappings includes one or more of a region attribute, a department attribute, and a commodity attribute.

In some embodiments, the techniques described herein relate to a non-transitory machine-readable medium, wherein the program further includes providing a graphical user interface (GUI) comprising a set of user interface (UI) controls for specifying the set of values for the set of attributes associated with the workspace, wherein the set of values for the set of attributes associated with the workspace are received through the GUI.

In some embodiments, the techniques described herein relate to a method including: receiving a request to create a workspace in which users can collaborate and a set of values for a set of attributes associated with the workspace: based on the set of values for the set of attributes, determining a set of users associated with the workspace: assigning the set of users to the workspace: and generating the workspace, the workspace including the set of values for the set of attributes and the set of users.

In some embodiments, the techniques described herein relate to a method, wherein the set of values for the set of attributes is a first set of values for a first set of attributes, the method further including: providing a first set of options for specifying the first set of values for the first set of attributes associated with the workspace upon receiving the first set of values for the first set of attributes associated with the workspace, providing a second set of options for specifying a second set of values for a second set of attributes associated with the workspace.

In some embodiments, the techniques described herein relate to a method, wherein determining the set of users associated with the workspace based on the set of values for the set of attributes includes: accessing a set of mappings, each mapping in the set of mappings specifying a user and values for a subset of the set of attributes: and identifying users with values for the subset of the set of attributes that match the set of values for the set of attributes.

In some embodiments, the techniques described herein relate to a method, wherein each mapping in the set of mappings further specifies a set of access control privileges for controlling access to the workspace by the user based on a status of the workspace, the method further including setting a status of the workspace to a first status.

In some embodiments, the techniques described herein relate to a method further including: receiving an input from a user in the set of users: and in response to receiving the input, setting the status of the workspace to a second status.

In some embodiments, the techniques described herein relate to a method, wherein the subset of the set of attributes specified in each mapping in the set of mappings includes one or more of a region attribute, a department attribute, and a commodity attribute.

In some embodiments, the techniques described herein relate to a method further including providing a graphical user interface (GUI) comprising a set of user interface (UI) controls for specifying the set of values for the set of attributes associated with the workspace, wherein the set of values for the set of attributes associated with the workspace are received through the GUI.

In some embodiments, the techniques described herein relate to a system including: a set of processing units: and a non-transitory machine-readable medium storing instructions that when executed by at least one processing unit in the set of processing units cause the at least one processing unit to: receive a request to create a workspace in which users can collaborate and a set of values for a set of attributes associated with the workspace: based on the set of values for the set of attributes, determine a set of users associated with the workspace; assign the set of users to the workspace: and generate the workspace, the workspace including the set of values for the set of attributes and the set of users.

In some embodiments, the techniques described herein relate to a system, wherein the set of values for the set of attributes is a first set of values for a first set of attributes, wherein the instructions further cause the at least one processing unit to: provide a first set of options for specifying the first set of values for the first set of attributes associated with the workspace upon receiving the first set of values for the first set of attributes associated with the workspace, provide a second set of options for specifying a second set of values for a second set of attributes associated with the workspace.

In some embodiments, the techniques described herein relate to a system, wherein determining the set of users associated with the workspace based on the set of values for the set of attributes includes: accessing a set of mappings, each mapping in the set of mappings specifying a user and values for a subset of the set of attributes: and identifying users with values for the subset of the set of attributes that match the set of values for the set of attributes.

In some embodiments, the techniques described herein relate to a system, wherein each mapping in the set of mappings further specifies a set of access control privileges for controlling access to the workspace by the user based on a status of the workspace, wherein the instructions further cause the at least one processing unit to set a status of the workspace to a first status.

In some embodiments, the techniques described herein relate to a system, wherein the instructions further cause the at least one processing unit to: receive an input from a user in the set of users; and in response to receiving the input, set the status of the workspace to a second status.

In some embodiments, the techniques described herein relate to a system, wherein the subset of the set of attributes specified in each mapping in the set of mappings includes one or more of a region attribute, a department attribute, and a commodity attribute.

The following detailed description and accompanying drawings provide a better understanding of the nature and advantages of various embodiments of the present disclosure.

### BRIEF DESCRIPTION OF THE DRAWINGS

FIG. 1 illustrates a system for managing workspaces according to some embodiments.

FIG. 2 illustrates an example graphical user interface (GUI) for creating a workspace according to some embodiments.

FIG. 3 illustrates an example GUI for adding information to a workspace according to some embodiments.

FIG. 4 illustrates an example GUI for providing details of a workspace according to some embodiments.

FIG. 5 illustrates an example GUI for managing users for a workspace according to some embodiments.

FIG. 6 illustrates an example GUI for providing an acknowledged workspace according to some embodiments.

FIG. 7 an example GUI for preparing a response for a workspace according to some embodiments.

FIG. 8 illustrates an example GUI for providing an analyzed workspace according to some embodiments.

FIG. 9 illustrates a process for creating a workspace according to some embodiments.

FIG. 10 illustrates an exemplary computer system, in which various embodiments may be implemented.

FIG. 11 illustrates an exemplary computing device, in which various embodiments may be implemented.

FIG. 12 illustrates an exemplary system, in which various embodiments may be implemented.

### DETAILED DESCRIPTION

In the following description, for purposes of explanation, numerous examples and specific details are set forth in order to provide a thorough understanding of the present disclosure. It will be evident, however, to one skilled in the art that various embodiment of the present disclosure as defined by the claims may include some or all of the features in these examples alone or in combination with other features described below, and may further include modifications and equivalents of the features and concepts described herein.

Described herein are techniques for managing workspaces for computing devices. In some embodiments, a computing system may receive from a client device values for attributes associated with a workspace along with a request to create the workspace. In response to the request, the computing system can determine a set of users to assign to the workspace. Depending on the role of a user and the status of the workspace, the user may have different permissions for accessing the workspace. Next, the computing system generates the workspace. The workspace allows the users assigned to the workspace to collaborate together.

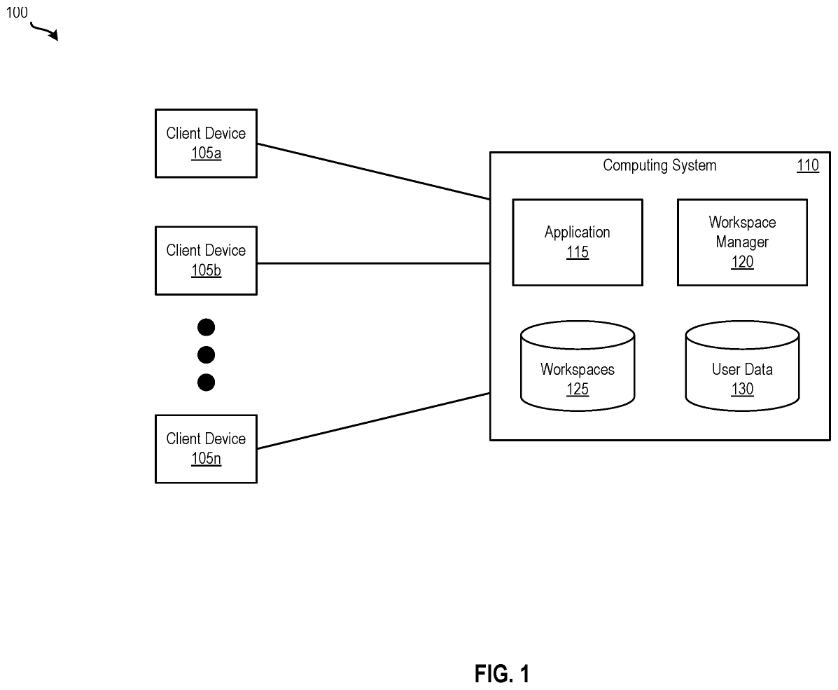

FIG. 1 illustrates a system 100 for managing workspaces according to some embodiments. As shown, system 100 include client devices 105a-n and computing system 110. Each of the client devices 105a-n is configured to interact with computing system 110. For example, a user of a client device 105 can access application 115 to create and manage workspaces. A user assigned to a workspace can interact with the workspace by using a client device 105 to access application 115.

As illustrated in FIG. 1, computing system 110 includes application 115, workspace manager 120, workspaces storage 125, and user data storage 130. Workspaces storage 125 stores workspaces. In some embodiments, a workspace specifies an entity, a set of commodities, a set of regions, a set of departments, a name, a type, a description, a status, etc. User data storage 130 stores user data. For instance, user data storage 130 can store a set of user records. Each user record can store information, such as a username, a region, a commodity, a department, a role, etc. In some embodiments, storages 125 and 130 are implemented in a single physical storage while, in other embodiments, storages 125 and 130 may be implemented across several physical storages. While FIG. 1 shows storages 125 and 130 as part of computing system 110, one of ordinary skill in the art will appreciate that workspaces storage 125 and/or user data storage 130 may be external to computing system 110 in some embodiments.

Application 115 is a software application operating on computing system 110 that facilitates the creation and management of collaborative workspaces. For instance, application 115 may provide a client device 105 with a graphical user interface (GUI) for creating such workspaces. Application 115 may receive, via the GUI, a request to create a workspace from a client device 105. The request may include information associated with the workspace, such as an entity, a set of commodities, a set of regions, a set of departments, etc. In response to the request, application 115 forwards the request to workspace manager 120 for processing. At various stages of the workspace, application 115 can receive other types of requests associated with the workspace, such as a request to edit the workspace, a request to add and/or edit users assigned to the workspace, a request to acknowledge the workspace, a request to reject the workspace, a request to create a response for the workspace, etc. Application 115 forwards these requests to workspace manager 120 for processing. In some instances, application 115 can receive from a client device 105 a request to access a workspace. In response to the request, application 115 accesses workspaces storage 125 to retrieve the workspace. Application 115 then provides the client device 105 the workspace via a GUI.

Workspace manager 120 is configured to manage workspaces. For example, workspace manager 120 may receive from application 115 a request to create a workspace along with information associated with the workspace. In response to the request, workspace manager 120 generates the workspace based on the information associated with the workspace. Then, workspace manager 120 stores the workspace in workspaces storage 125. In addition, workspace manager 120 can receive from application 115 a request to edit the workspace, a request to add and/or edit users assigned to the workspace, a request to acknowledge the workspace, a request to reject the workspace, a request to create a response for the workspace, etc. In response any of these requests, workspace manager 120 accesses workspaces storage 125 and updates the workspace accordingly.

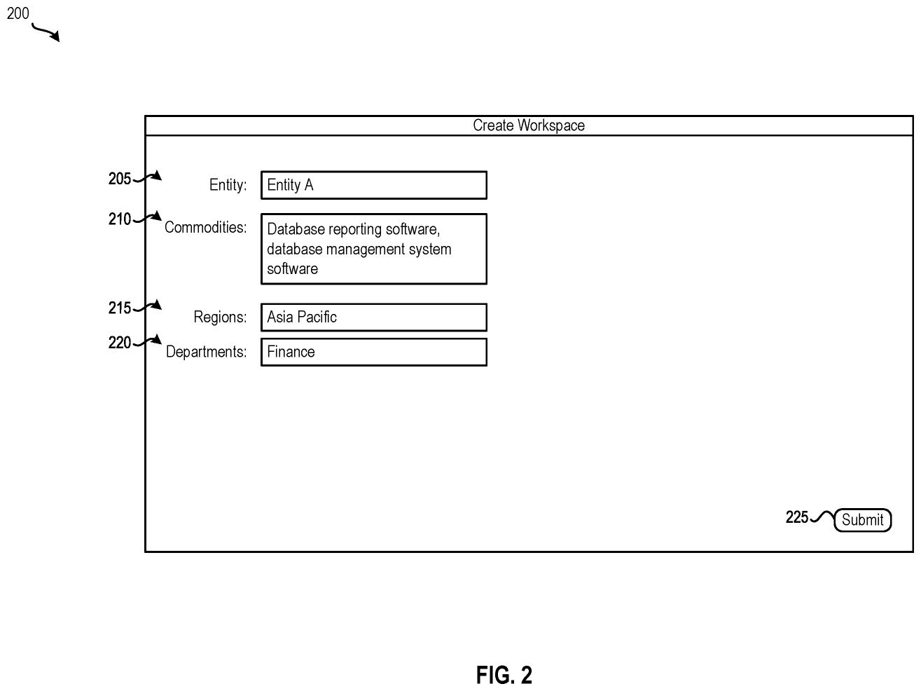

An example operation of system 100 will now be described by reference to FIGS. 1-8. The example operation will show how a collaborative workspace is created and managed according to some embodiments. The operation begins by a user of client device 105a accessing a GUI provided by application 115 for creating a workspace. FIG. 2 illustrates an example GUI 200 for creating a workspace according to some embodiments. For this example, application 115 provides GUI 200 to client device 105a and the user of client device 105a uses it to create a collaborative workspace.

As depicted in FIG. 2, GUI 200 includes user interface (UI) controls 205-225. UI control 205 is a textbox control configured to receive an entity, UI control 210 is a textbox control configured to receive a set of commodities, UI control 215 is a textbox control configured to receive a set of regions, and UI control 220 is a textbox control configured to receive a set of departments. UI control 225 is a selectable UI control for creating a workspace. After the user of client device 105a entered the information shown in UI controls 205-220, the user selects UI control 225 to create the workspace. The selection of UI control 220 causes client device 105a to send application 115 the information provided via UI controls 205-220 and a request to create a workspace.

Once application 115 receives the information and the request, application 115 forwards them to workspace manager 120. When workspace manager 120 receives the request and the information associated with the workspace (the information provided via UI controls 205-220 in this example), workspace manager 120 generates the workspace, which includes the information associated with the workspace, and stores the workspace in workspaces storage 125. Then, application 115 provides client device 105a with a GUI for adding information to the workspace.

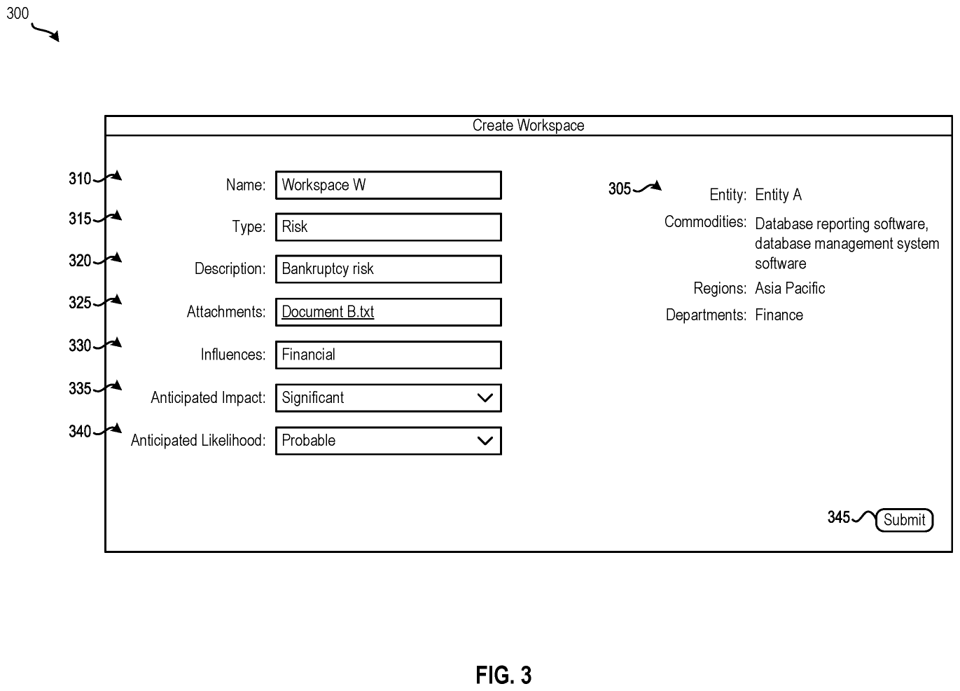

FIG. 3 illustrates an example GUI 300 for adding information to a workspace according to some embodiments. In this example, application 115 provides GUI 300 to client device 105a after the user of client device 105a creates the workspace using GUI 200. As illustrated, GUI 300 includes workspace information 305 and UI controls 310-345. Workspace information 305 displays the information provided via UI controls 205-220 in FIG. 2. UI control 310 is a textbox control configured to receive a name, UI control 315 is a textbox control configured to receive a type of workspace, UI control 320 is a textbox control configured to receive a description, UI control 325 is a file upload control configured to receive attachments (e.g., files such as documents, spreadsheets, slides, photos, etc.), UI control 330 is a textbox control configured to receive a set of influences, UI control 335 is a drop-down control configured to receive a selection of an anticipated impact, and UI control 340 is a drop-down control configured to receive an anticipated likelihood. UI control 345 is a selectable UI control for adding information to the workspace created via GUI 200. Receiving a selection of UI control 325 by the user of client device 105a causes client device 105a to send application 115 the information provided via UI controls 310-340 and a request to add the information to workspace created through GUI 200.

Upon receiving the information and the request from client device 105a, application 115 forwards them to workspace manager 120. In response, workspace manager 120 accesses workspaces storage 125 and updates the workspace with the information provided via UI controls 310-340. In addition, workspace manager 120 updates the status of the workspace to “In Validation.” Next, application 115 provides client device 105a with a GUI for providing details of the newly created workspace.

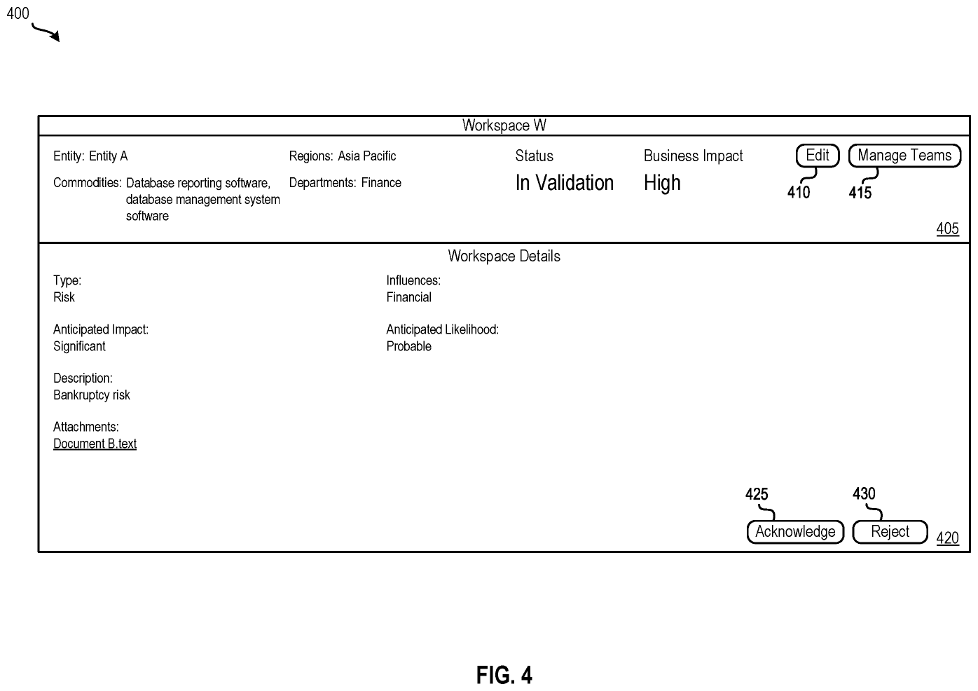

FIG. 4 illustrates an example GUI 400 for providing details of a workspace according to some embodiments. For this example, application 115 provides GUI 400 to client device 105a after the user of client device 105a added the information to the workspace using GUI 300. As shown in FIG. 4, GUI 400 includes sections 405 and 420. Section 405 is for displaying some information associated with the workspace. In particular, section 405 displays the entity, the set of commodities, the set of regions, the set of departments, the status, and the business impact. Section 405 also includes UI controls 410 and 415. UI control 410 is a selectable UI control for editing the workspace and UI control 415 is a selectable UI control for managing users associated with the workspace.

As depicted in FIG. 4, section 420 is for displaying additional details associated with the workspace. Specifically, section 420 displays the type of workspace, the description, the attachments, the set of influences, the anticipated impact, and the anticipated likelihood. In addition, section 420) includes UI controls 425 and 430. UI control 425 is a selectable UI control for acknowledging the workspace and UI control 430 is a selectable UI control for rejecting the workspace.

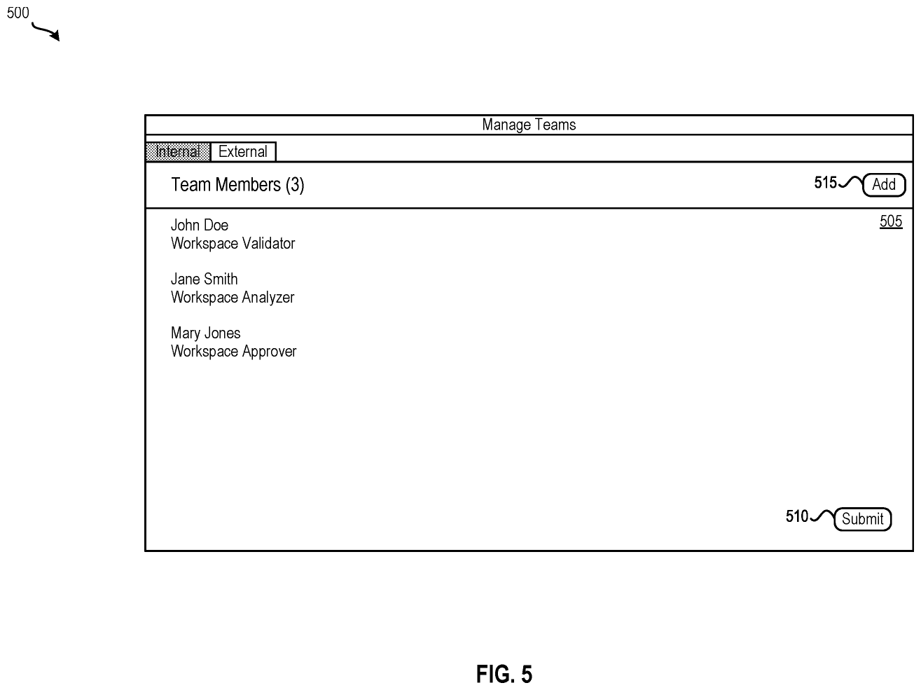

In this example, the user of client device 105a selects UI control 415, which causes application 115 to provide client device 105a with a GUI for managing users for the workspace. FIG. 5 illustrates an example GUI 500 for managing users for a workspace according to some embodiments. Here, application 115 provides GUI 500 to client device 105a after the user of client device 105a selects UI control 415. In some embodiments, application 115 may provide GUI 500 alongside GUI 400. As illustrated, GUI 500 includes section 505 for displaying users assigned to the workspace. In some embodiments, when workspace manager 120 creates a new workspace, workspace manager 120 automatically determines a set of users to assign to the new workspace. In some such embodiments, workspace manager 120 determines the set of users by accessing user data storage 130 to identify the set of users based on matching attribute values. As mentioned above, user data storage 130 may store a set of user records that each stores information, such as a username, a region, a commodity, a department, a role, etc. Each user record effectively serves as a mapping between a user (e.g., a username) and a set of values for a set of attributes (e.g., a region, a commodity, a department, a role, etc.). In some embodiments, each mapping specifies a set of access control privileges associated with the specified role. The set of access control privileges controls access to the workspace (e.g., read access, write access, etc.) based on the status of the workspace. For instance, a first set of access control privileges in a first user record may specify that a first user has read and write access to the workspace only when the workspace is in a “In Validation” status: a second set of access control privileges in a second user record can specify that a second user has read and write access to the workspace only when the workspace is in a “In Analysis” status: a third set of access control privileges in a third user record can specify that a third user has read and write access to the workspace only when the workspace is in a “In Response Approval” status: etc. For this example, workspace manager 120 can identify users in user data storage 130 by accessing the mappings stored in user data storage 130 and finding, based on the mappings, users that have matching commodities, regions, and departments. In particular, workspace manager 120 would identify users specified in the mappings stored in user data storage 130 that have a database reporting software commodity value, an Asia Pacific region value, and a finance department value. Workspace manager 120 would also identify users specified in the mappings stored in user data storage 130 that have or a database management system software commodity value, an Asia Pacific region value, and a finance department value. GUI 500 shows the set of users and their respective roles that workspace manager 120 automatically determined for the workspace in this example. As shown, user John Doe has a workspace validator role, user Jane Smith has a workspace analyzer role, and user Mary Jones has a workspace approver role. GUI 500 also includes UI controls 510 and 515. UI control 510 is a selectable UI control configured to update the users assigned to the workspace and UI control is a selectable UI control configured to manually select users from user data storage 130 and assign them to the workspace. Here, the user of client device 105a selects UI control 510 to return back to GUI 400.

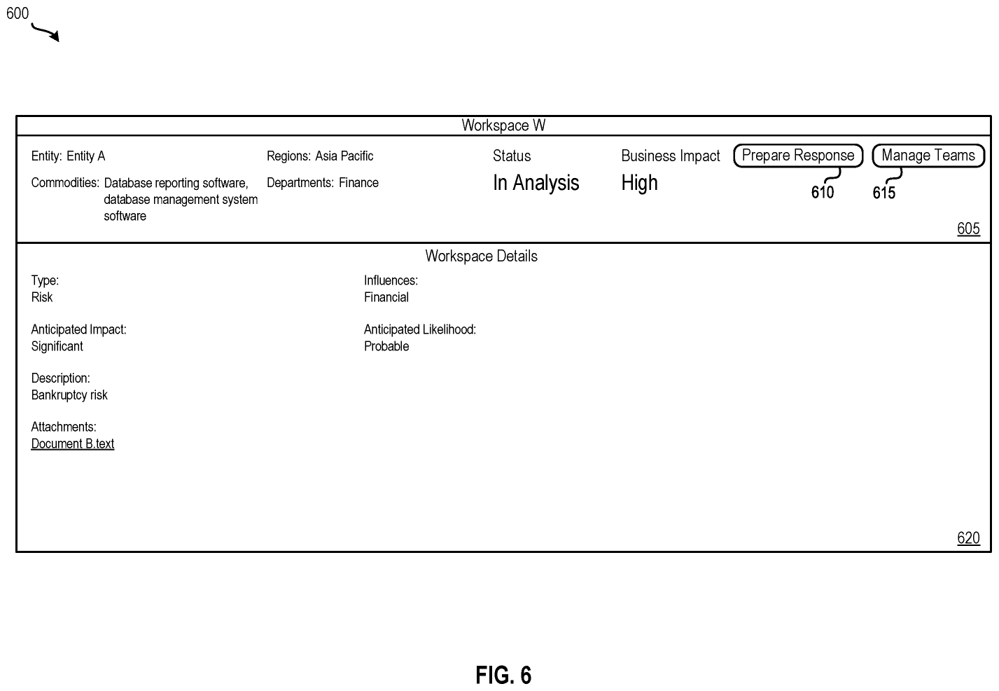

Now, the John Doe user uses client device 105b to log into application 115 and access the workspace via GUI 400. As mentioned above, John Doe has a workspace validator role; this role allows the user to acknowledge or reject the workspace. In this example, John Doe uses client device 105b to select UI control 425 to acknowledge the workspace. The selection of UI control 425 causes application 115 to change the status of the workspace from “In Validation” to “In Analysis.” In this example, the Jane Smith user now uses client device 105c to log into application 115. Upon logging into application 115, application 115 provides client device 105a with a GUI for providing the acknowledged workspace. FIG. 6 illustrates an example GUI 600 for providing an acknowledged workspace according to some embodiments. In this example, application 115 provides GUI 600 to client device 105b after Jane Smith logs into application 115. As depicted, GUI 600 includes sections 605 and 620. Section 605 is similar to section 405 except section 605 includes UI controls 610 and 615. Here, section 605 is displaying the current status of the workspace, which is “In Analysis.” UI control 610 is a selectable UI control preparing a response for the workspace. UI control 615 is similar to UI control 415. Section 620 is similar to section 420 in that section 620 is for displaying additional details associated with the workspace.

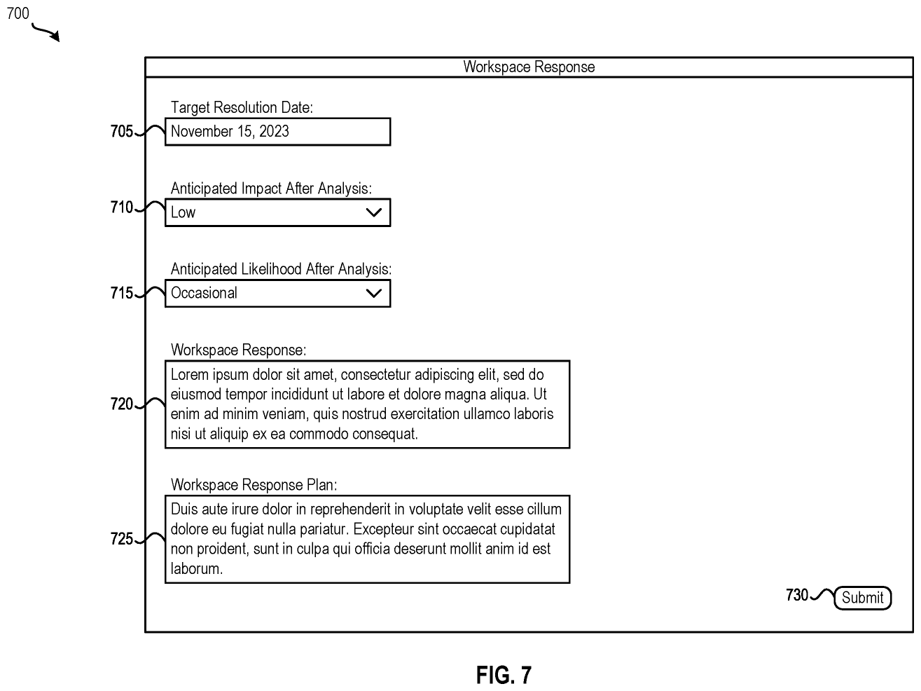

As described above, Jane Smith has a workspace analyzer role: this role allows the 30) user to analyze and create a response for the workspace. For this example, Jane Smith uses client device 105b to select UI control 610. When application 115 receives the selection, application 115 provides client device 105b a GUI for preparing a response for a workspace. FIG. 7 illustrates an example GUI 700 for preparing a response for a workspace according to some embodiments. For this example, application 115 provides GUI 700 to client device 105b after Jane Smith uses client device 105a to select UI control 610. In some embodiments, application 115 can provide GUI 700 alongside GUI 600. As illustrated, GUI 700 includes UI controls 705-730. UI control 705 is a textbox control configured to receive a target resolution date. UI control 710 is a drop-down control configured to receive a selection of an anticipated impact after analysis. UI control 715 is a drop-down control configured to receive a selection of an anticipated likelihood after analysis. UI control 720 is a textbox control configured to receive a workspace response and UI control 725 is a textbox control configured to receive a workspace response plan. UI control 730 is a selectable UI control for creating a response for a workspace. Here, after the user of client device 105a entered the information shown in UI controls 705-725, the user selects UI control 730 to create a response for the workspace. The selection of UI control 730 causes client device 105a to send application 115 the information provided via UI controls 705-725 and a request to create a response for the workspace.

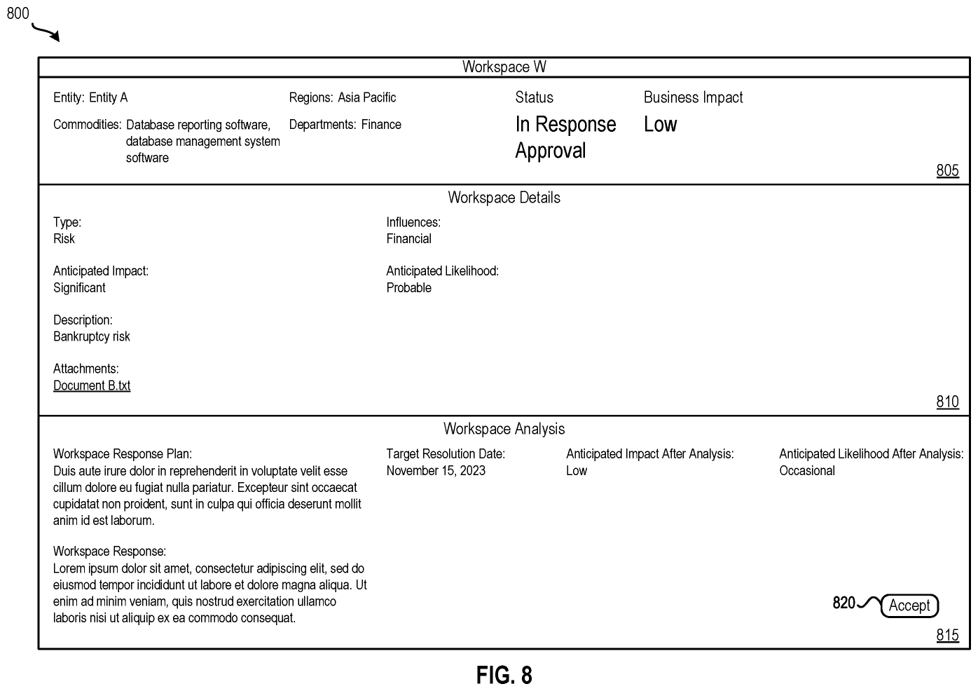

When application 115 receives the information and the request, application 115 forwards them to workspace manager 120. Upon receiving the request and the information associated with the response for the workspace (the information provided via UI controls 705-725 in this example), workspace manager 120 generates the response for the workspace and then accesses workspaces storage 125 to update the workspace to include the response. Then, application 115 changes the status of the workspace from “In Analysis” to “In Response Approval.” Next, the Mary Jones user uses client device 105c to log into application 115. Upon logging into application 115, application 115 provides client device 105c with a GUI for providing the analyzed workspace. FIG. 8 illustrates an example GUI 800 for providing an analyzed workspace according to some embodiments. For this example, application 115 provides GUI 800 to client device 105c after Mary Jones logs into application 115. As shown. GUI 800 includes sections 805-815. Section 805 is similar to section 605 except section 805 is displaying the current status of the workspace, which is “Completed.” Section 810 is similar to section 620 in that section 810 is for displaying additional details associated with the workspace. Section 815 is for displaying details of the response for the workspace. Also, section 815 includes a UI control 820, which is a selectable UI control for accepting the workspace. As mentioned above, Mary Jones has a workspace approver role: this role allows the user to approve the workspace. Here, Mary Jones uses client device 105c to select UI control 820 to accept the workspace. Once application 115 receives the selection of UI control 820, application 115 changes the status of the workspace from “In Response Approval” to “Completed.”

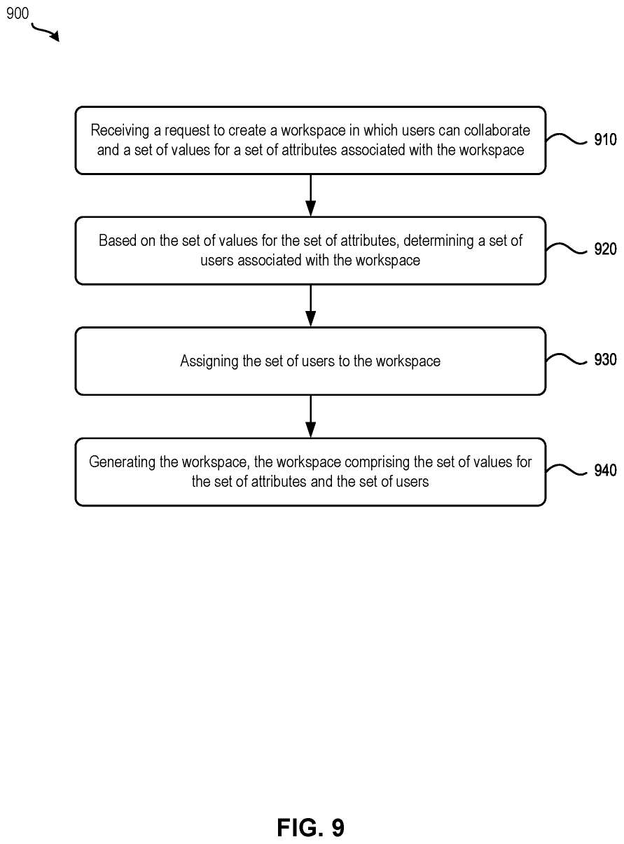

FIG. 9 illustrates a process 900 for creating a workspace according to some embodiments. In some embodiments, computing system 110 performs process 900. Process 900 starts by receiving, at 910, a request to create a workspace in which users can collaborate and a set of values for a set of attributes associated with the workspace. Referring to FIGS. 1 and 2 as an example, application 115 may receive from client device 105a the request to create the collaborative workspace and the set of values for the set of attributes associated with the workspace via UI controls 205-220. Application 115 forwards the request and the set of values for the set of attributes to workspace manager 120 for processing.

Based on the set of values for the set of attributes, process 900 determines, at 920, a set of users associated with the workspace. Referring to FIG. 1 as an example, when workspace manager 120 creates the collaborative workspace, workspace manager 120 automatically determines a set of users to assign to the new workspace. For instance, workspace manager 120 determines the set of users by accessing user data storage 130 to identify the set of users based on matching attribute values (e.g., matching commodities, regions, and departments).

At 930, process 900 assigns, the set of users to the workspace. Referring to FIG. 1 as an example, workspace manager 120 assigns the set of users after workspace manager 120 determines the set of users for the workspace. Finally, process 900 generates, at 940, the workspace. The workspace includes the set of values for the set of attributes and the set of users. Referring to FIG. 1 as an example, workspace manager 120 generates the workspace, which includes the information associated with the workspace, and stores the workspace in workspaces storage 125.

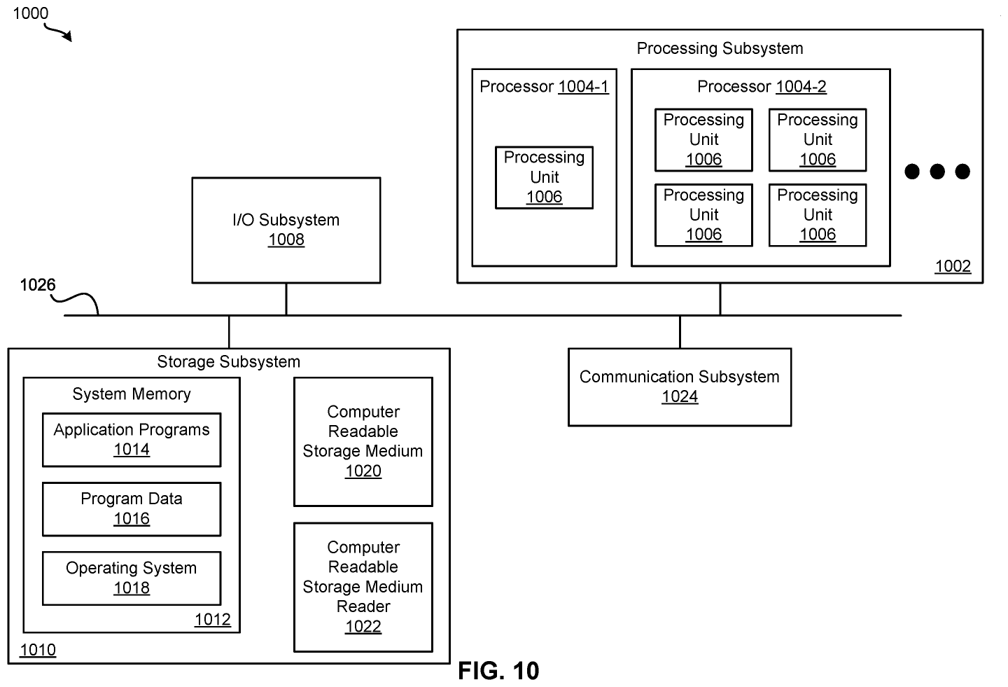

FIG. 10 illustrates an exemplary computer system 1000 for implementing various embodiments described above. For example, computer system 1000 may be used to implement client devices 105a-n and computing system 110. Computer system 1000 may be a desktop computer, a laptop, a server computer, or any other type of computer system or combination thereof. Some or all elements of application 115, workspace manager 120, or combinations thereof can be included or implemented in computer system 1000. In addition, computer system 1000 can implement many of the operations, methods, and/or processes described above (e.g., process 900). As shown in FIG. 10, computer system 1000 includes processing subsystem 1002, which communicates, via bus subsystem 1026, with input/output (I/O) subsystem 1008, storage subsystem 1010 and communication subsystem 1024.

Bus subsystem 1026 is configured to facilitate communication among the various components and subsystems of computer system 1000. While bus subsystem 1026 is illustrated in FIG. 10 as a single bus, one of ordinary skill in the art will understand that bus subsystem 1026 may be implemented as multiple buses. Bus subsystem 1026 may be any of several types of bus structures (e.g., a memory bus or memory controller, a peripheral bus, a local bus, etc.) using any of a variety of bus architectures. Examples of bus architectures may include an Industry Standard Architecture (ISA) bus, a Micro Channel Architecture (MCA) bus, an Extended ISA (EISA) bus, a Video Electronics Standards Association (VESA) local bus, a Peripheral Component Interconnect (PCI) bus, a Universal Serial Bus (USB), etc.

Processing subsystem 1002, which can be implemented as one or more integrated circuits (e.g., a conventional microprocessor or microcontroller), controls the operation of computer system 1000. Processing subsystem 1002 may include one or more processors 1004. Each processor 1004 may include one processing unit 1006 (e.g., a single core processor such as processor 1004-1) or several processing units 1006 (e.g., a multicore processor such as processor 1004-2). In some embodiments, processors 1004 of processing subsystem 1002 may be implemented as independent processors while, in other embodiments, processors 1004 of processing subsystem 1002 may be implemented as multiple processors integrate into a single chip or multiple chips. Still, in some embodiments, processors 1004 of processing subsystem 1002 may be implemented as a combination of independent processors and multiple processors integrated into a single chip or multiple chips.

In some embodiments, processing subsystem 1002 can execute a variety of programs or processes in response to program code and can maintain multiple concurrently executing programs or processes. At any given time, some or all of the program code to be executed can reside in processing subsystem 1002 and/or in storage subsystem 1010. Through suitable programming, processing subsystem 1002 can provide various functionalities, such as the functionalities described above by reference to process 900.

I/O subsystem 1008 may include any number of user interface input devices and/or user interface output devices. User interface input devices may include a keyboard, pointing devices (e.g., a mouse, a trackball, etc.), a touchpad, a touch screen incorporated into a display, a scroll wheel, a click wheel, a dial, a button, a switch, a keypad, audio input devices with voice recognition systems, microphones, image/video capture devices (e.g., webcams, image scanners, barcode readers, etc.), motion sensing devices, gesture recognition devices, eye gesture (e.g., blinking) recognition devices, biometric input devices, and/or any other types of input devices.

User interface output devices may include visual output devices (e.g., a display subsystem, indicator lights, etc.), audio output devices (e.g., speakers, headphones, etc.), etc. Examples of a display subsystem may include a cathode ray tube (CRT), a flat-panel device (e.g., a liquid crystal display (LCD), a plasma display, etc.), a projection device, a touch screen, and/or any other types of devices and mechanisms for outputting information from computer system 1000 to a user or another device (e.g., a printer).

As illustrated in FIG. 10, storage subsystem 1010 includes system memory 1012, computer-readable storage medium 1020, and computer-readable storage medium reader 1022. System memory 1012 may be configured to store software in the form of program instructions that are loadable and executable by processing subsystem 1002 as well as data generated during the execution of program instructions. In some embodiments, system memory 1012 may include volatile memory (e.g., random access memory (RAM)) and/or non-volatile memory (e.g., read-only memory (ROM), programmable read-only memory (PROM), erasable programmable read-only memory (EPROM), electrically erasable programmable read-only memory (EEPROM), flash memory, etc.). System memory 1012 may include different types of memory, such as static random access memory (SRAM) and/or dynamic random access memory (DRAM). System memory 1012 may include a basic input/output system (BIOS), in some embodiments, that is configured to store basic routines to facilitate transferring information between elements within computer system 1000 (e.g., during start-up). Such a BIOS may be stored in ROM (e.g., a ROM chip), flash memory, or any other type of memory that may be configured to store the BIOS.

As shown in FIG. 10, system memory 1012 includes application programs 1014 (e.g., application 115), program data 1016, and operating system (OS) 1018. OS 1018 may be one of various versions of Microsoft Windows, Apple Mac OS, Apple OS X, Apple macOS, and/or Linux operating systems, a variety of commercially-available UNIX or UNIX-like operating systems (including without limitation the variety of GNU/Linux operating systems, the Google Chrome® OS, and the like) and/or mobile operating systems such as Apple IOS, Windows Phone, Windows Mobile, Android, BlackBerry OS, Blackberry 10, and Palm OS, WebOS operating systems.

Computer-readable storage medium 1020 may be a non-transitory computer-readable medium configured to store software (e.g., programs, code modules, data constructs, instructions, etc.). Many of the components (e.g., application 115 and workspace manager 120) and/or processes (e.g., process 900) described above may be implemented as software that when executed by a processor or processing unit (e.g., a processor or processing unit of processing subsystem 1002) performs the operations of such components and/or processes. Storage subsystem 1010 may also store data used for, or generated during, the execution of the software.

Storage subsystem 1010 may also include computer-readable storage medium reader 1022 that is configured to communicate with computer-readable storage medium 1020. Together and, optionally, in combination with system memory 1012, computer-readable storage medium 1020 may comprehensively represent remote, local, fixed, and/or removable storage devices plus storage media for temporarily and/or more permanently containing, storing, transmitting, and retrieving computer-readable information.

Computer-readable storage medium 1020 may be any appropriate media known or used in the art, including storage media such as volatile, non-volatile, removable, non-removable media implemented in any method or technology for storage and/or transmission of information. Examples of such storage media includes RAM, ROM, EEPROM, flash memory or other memory technology, compact disc read-only memory (CD-ROM), digital versatile disk (DVD), Blu-ray Disc (BD), magnetic cassettes, magnetic tape, magnetic disk storage (e.g., hard disk drives), Zip drives, solid-state drives (SSDs), flash memory card (e.g., secure digital (SD) cards, CompactFlash cards, etc.), USB flash drives, or any other type of computer-readable storage media or device.

Communication subsystem 1024 serves as an interface for receiving data from, and transmitting data to, other devices, computer systems, and networks. For example, communication subsystem 1024 may allow computer system 1000 to connect to one or more devices via a network (e.g., a personal area network (PAN), a local area network (LAN), a storage area network (SAN), a campus area network (CAN), a metropolitan area network (MAN), a wide area network (WAN), a global area network (GAN), an intranet, the Internet, a network of any number of different types of networks, etc.). Communication subsystem 1024 can include any number of different communication components. Examples of such components may include radio frequency (RF) transceiver components for accessing wireless voice and/or data networks (e.g., using cellular technologies such as 2G, 3G, 4G, 5G, etc., wireless data technologies such as Wi-Fi, Bluetooth, ZigBee, etc., or any combination thereof), global positioning system (GPS) receiver components, and/or other components. In some embodiments, communication subsystem 1024 may provide components configured for wired communication (e.g., Ethernet) in addition to or instead of components configured for wireless communication.

One of ordinary skill in the art will realize that the architecture shown in FIG. 10 is only an example architecture of computer system 1000, and that computer system 1000 may have additional or fewer components than shown, or a different configuration of components. The various components shown in FIG. 10 may be implemented in hardware, software, firmware or any combination thereof, including one or more signal processing and/or application specific integrated circuits.

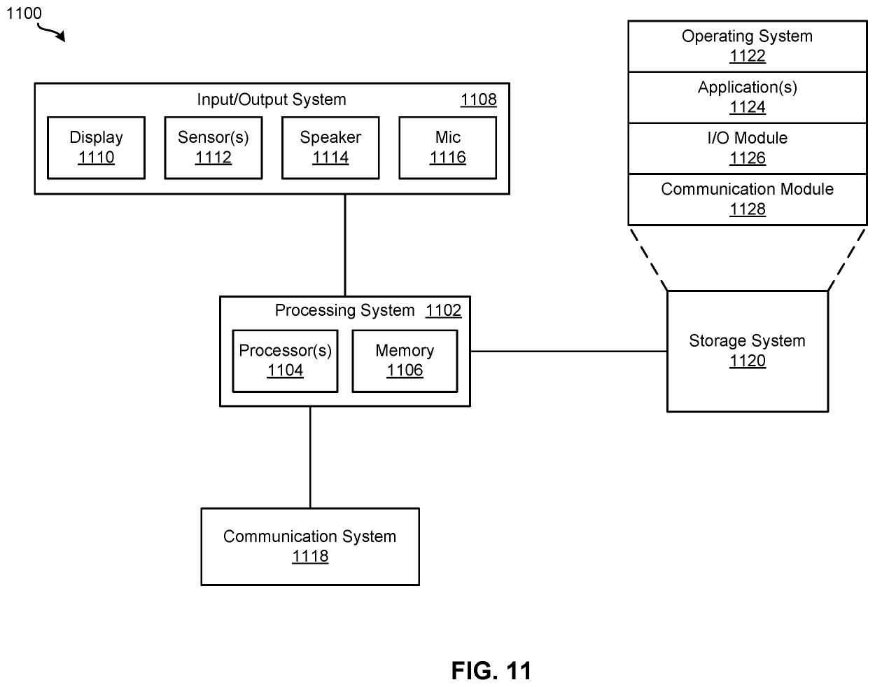

FIG. 11 illustrates an exemplary computing device 1100 for implementing various embodiments described above. For example, computing device 1100 may be used to implement client devices 105a-n. Computing device 1100 may be a cellphone, a smartphone, a wearable device, an activity tracker or manager, a tablet, a personal digital assistant (PDA), a media player, or any other type of mobile computing device or combination thereof. As shown in FIG. 11, computing device 1100 includes processing system 1102, input/output (I/O) system 1108, communication system 1118, and storage system 1120. These components may be coupled by one or more communication buses or signal lines.

Processing system 1102, which can be implemented as one or more integrated circuits (e.g., a conventional microprocessor or microcontroller), controls the operation of computing device 1100. As shown, processing system 1102 includes one or more processors 1104 and memory 1106. Processors 1104 are configured to run or execute various software and/or sets of instructions stored in memory 1106 to perform various functions for computing device 1100 and to process data.

Each processor of processors 1104 may include one processing unit (e.g., a single core processor) or several processing units (e.g., a multicore processor). In some embodiments, processors 1104 of processing system 1102 may be implemented as independent processors while, in other embodiments, processors 1104 of processing system 1102 may be implemented as multiple processors integrated into a single chip. Still, in some embodiments, processors 1104 of processing system 1102 may be implemented as a combination of independent processors and multiple processors integrated into a single chip.

Memory 1106 may be configured to receive and store software (e.g., operating system 1122, applications 1124, I/O module 1126, communication module 1128, etc. from storage system 1120) in the form of program instructions that are loadable and executable by processors 1104 as well as data generated during the execution of program instructions. In some embodiments, memory 1106 may include volatile memory (e.g., random access memory (RAM)), non-volatile memory (e.g., read-only memory (ROM), programmable read-only memory (PROM), erasable programmable read-only memory (EPROM), electrically erasable programmable read-only memory (EEPROM), flash memory, etc.), or a combination thereof.

I/O system 1108 is responsible for receiving input through various components and providing output through various components. As shown for this example, I/O system 1108 includes display 1110, one or more sensors 1112, speaker 1114, and microphone 1116. Display 1110 is configured to output visual information (e.g., a graphical user interface (GUI) generated and/or rendered by processors 1104). In some embodiments, display 1110 is a touch screen that is configured to also receive touch-based input. Display 1110 may be implemented using liquid crystal display (LCD) technology, light-emitting diode (LED) technology, organic LED (OLED) technology, organic electro luminescence (OEL) technology, or any other type of display technologies. Sensors 1112 may include any number of different types of sensors for measuring a physical quantity (e.g., temperature, force, pressure, acceleration, orientation, light, radiation, etc.). Speaker 1114 is configured to output audio information and microphone 1116 is configured to receive audio input. One of ordinary skill in the art will appreciate that I/O system 1108 may include any number of additional, fewer, and/or different components. For instance, I/O system 1108 may include a keypad or keyboard for receiving input, a port for transmitting data, receiving data and/or power, and/or communicating with another device or component, an image capture component for capturing photos and/or videos, etc.

Communication system 1118 serves as an interface for receiving data from, and transmitting data to, other devices, computer systems, and networks. For example, communication system 1118 may allow computing device 1100 to connect to one or more devices via a network (e.g., a personal area network (PAN), a local area network (LAN), a storage area network (SAN), a campus area network (CAN), a metropolitan area network (MAN), a wide area network (WAN), a global area network (GAN), an intranet, the Internet, a network of any number of different types of networks, etc.). Communication system 1118 can include any number of different communication components. Examples of such components may include radio frequency (RF) transceiver components for accessing wireless voice and/or data networks (e.g., using cellular technologies such as 2G, 3G, 4G, 5G, etc., wireless data technologies such as Wi-Fi, Bluetooth, ZigBee, etc., or any combination thereof), global positioning system (GPS) receiver components, and/or other components. In some embodiments, communication system 1118 may provide components configured for wired communication (e.g., Ethernet) in addition to or instead of components configured for wireless communication.

Storage system 1120 handles the storage and management of data for computing device 1100. Storage system 1120 may be implemented by one or more non-transitory machine-readable mediums that are configured to store software (e.g., programs, code modules, data constructs, instructions, etc.) and store data used for, or generated during, the execution of the software.

In this example, storage system 1120 includes operating system 1122, one or more applications 1124, I/O module 1126, and communication module 1128. Operating system 1122 includes various procedures, sets of instructions, software components and/or drivers for controlling and managing general system tasks (e.g., memory management, storage device control, power management, etc.) and facilitates communication between various hardware and software components. Operating system 1122 may be one of various versions of Microsoft Windows, Apple Mac OS, Apple OS X, Apple macOS, and/or Linux operating systems, a variety of commercially-available UNIX or UNIX-like operating systems (including without limitation the variety of GNU/Linux operating systems, the Google Chrome R: OS, and the like) and/or mobile operating systems such as Apple IOS, Windows Phone, Windows Mobile, Android, BlackBerry OS, Blackberry 10, and Palm OS, WebOS operating systems.

Applications 1124 can include any number of different applications installed on computing device 1100. Examples of such applications may include a browser application, an address book application, a contact list application, an email application, an instant messaging application, a word processing application, JAVA-enabled applications, an encryption application, a digital rights management application, a voice recognition application, location determination application, a mapping application, a music player application, etc.

I/O module 1126 manages information received via input components (e.g., display 1110, sensors 1112, and microphone 1116) and information to be outputted via output components (e.g., display 1110 and speaker 1114). Communication module 1128 facilitates communication with other devices via communication system 1118 and includes various software components for handling data received from communication system 1118.

One of ordinary skill in the art will realize that the architecture shown in FIG. 11 is only an example architecture of computing device 1100, and that computing device 1100 may have additional or fewer components than shown, or a different configuration of components. The various components shown in FIG. 11 may be implemented in hardware, software, firmware or any combination thereof, including one or more signal processing and/or application specific integrated circuits.

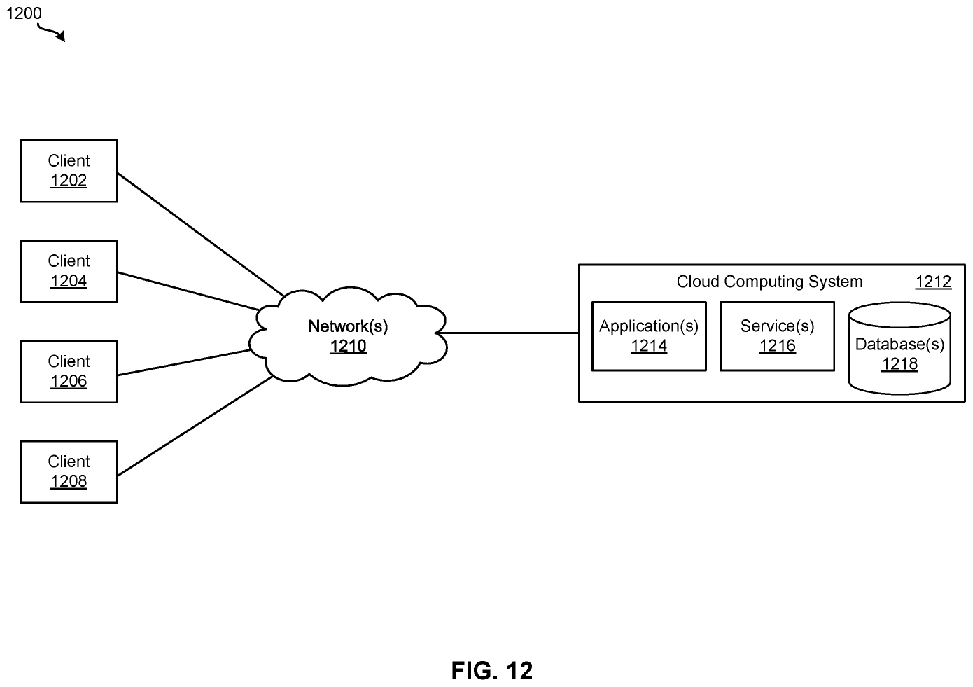

FIG. 12 illustrates an exemplary system 1200 for implementing various embodiments described above. For example, client devices 1202-1208 may be used to implement client devices 105a-n and cloud computing system 1212 may be used to implement computing system 110. As shown, system 1200 includes client devices 1202-1208, one or more networks 1210, and cloud computing system 1212. Cloud computing system 1212 is configured to provide resources and data to client devices 1202-1208 via networks 1210. In some embodiments, cloud computing system 1212 provides resources to any number of different users (e.g., customers, tenants, organizations, etc.). Cloud computing system 1212 may be implemented by one or more computer systems (e.g., servers), virtual machines operating on a computer system, or a combination thereof.

As shown, cloud computing system 1212 includes one or more applications 1214, one or more services 1216, and one or more databases 1218. Cloud computing system 1212 may provide applications 1214, services 1216, and databases 1218 to any number of different customers in a self-service, subscription-based, elastically scalable, reliable, highly available, and secure manner.

In some embodiments, cloud computing system 1212 may be adapted to automatically provision, manage, and track a customer's subscriptions to services offered by cloud computing system 1212. Cloud computing system 1212 may provide cloud services via different deployment models. For example, cloud services may be provided under a public cloud model in which cloud computing system 1212 is owned by an organization selling cloud services and the cloud services are made available to the general public or different industry enterprises. As another example, cloud services may be provided under a private cloud model in which cloud computing system 1212 is operated solely for a single organization and may provide cloud services for one or more entities within the organization. The cloud services may also be provided under a community cloud model in which cloud computing system 1212 and the cloud services provided by cloud computing system 1212 are shared by several organizations in a related community. The cloud services may also be provided under a hybrid cloud model, which is a combination of two or more of the aforementioned different models.

In some instances, any one of applications 1214, services 1216, and databases 1218 made available to client devices 1202-1208 via networks 1210 from cloud computing system 1212 is referred to as a “cloud service.” Typically, servers and systems that make up cloud computing system 1212 are different from the on-premises servers and systems of a customer. For example, cloud computing system 1212 may host an application and a user of one of client devices 1202-1208 may order and use the application via networks 1210.

Applications 1214 may include software applications that are configured to execute on cloud computing system 1212 (e.g., a computer system or a virtual machine operating on a computer system) and be accessed, controlled, managed, etc. via client devices 1202-1208. In some embodiments, applications 1214 may include server applications and/or mid-tier applications (e.g., HTTP (hypertext transfer protocol) server applications, FTP (file transfer protocol) server applications, CGI (common gateway interface) server applications, JAVA server applications, etc.). Services 1216 are software components, modules, application, etc. that are configured to execute on cloud computing system 1212 and provide functionalities to client devices 1202-1208 via networks 1210. Services 1216 may be web-based services or on-demand cloud services.

Databases 1218 are configured to store and/or manage data that is accessed by applications 1214, services 1216, and/or client devices 1202-1208. For instance, storages 125 and 130 may be stored in databases 1218. Databases 1218 may reside on a non-transitory storage medium local to (and/or resident in) cloud computing system 1212, in a storage-area network (SAN), on a non-transitory storage medium local located remotely from cloud computing system 1212. In some embodiments, databases 1218 may include relational databases that are managed by a relational database management system (RDBMS). Databases 1218 may be a column-oriented databases, row-oriented databases, or a combination thereof. In some embodiments, some or all of databases 1218 are in-memory databases. That is, in some such embodiments, data for databases 1218 are stored and managed in memory (e.g., random access memory (RAM)).

Client devices 1202-1208 are configured to execute and operate a client application (e.g., a web browser, a proprietary client application, etc.) that communicates with applications 1214, services 1216, and/or databases 1218 via networks 1210. This way, client devices 1202-1208 may access the various functionalities provided by applications 1214, services 1216, and databases 1218 while applications 1214, services 1216, and databases 1218 are operating (e.g., hosted) on cloud computing system 1212. Client devices 1202-1208 may be computer system 1000 or computing device 1100, as described above by reference to FIGS. 10 and 11, respectively. Although system 1200 is shown with four client devices, any number of client devices may be supported.

Networks 1210 may be any type of network configured to facilitate data communications among client devices 1202-1208 and cloud computing system 1212 using any of a variety of network protocols. Networks 1210 may be a personal area network (PAN), a local area network (LAN), a storage area network (SAN), a campus area network (CAN), a metropolitan area network (MAN), a wide area network (WAN), a global area network (GAN), an intranet, the Internet, a network of any number of different types of networks, etc.

The above description illustrates various embodiments of the present disclosure along with examples of how aspects of the present disclosure may be implemented. The above examples and embodiments should not be deemed to be the only embodiments, and are presented to illustrate the flexibility and advantages of various embodiments of the present disclosure as defined by the following claims. Based on the above disclosure and the following claims, other arrangements, embodiments, implementations and equivalents will be evident to those skilled in the art and may be employed without departing from the spirit and scope of the present disclosure as defined by the claims.

What is claimed is:

1. A non-transitory machine-readable medium storing a program executable by at least one processing unit of a device, the program comprising sets of instructions for:
receiving a request to create a workspace in which users can collaborate and a set of values for a set of attributes associated with the workspace;
based on the set of values for the set of attributes, determining a set of users associated with the workspace;
assigning the set of users to the workspace; and
generating the workspace, the workspace comprising the set of values for the set of attributes and the set of users.

2. The non-transitory machine-readable medium of claim 1, wherein the set of values for the set of attributes is a first set of values for a first set of attributes, wherein the program further comprises sets of instructions for:
providing a first set of options for specifying the first set of values for the first set of attributes associated with the workspace
upon receiving the first set of values for the first set of attributes associated with the workspace, providing a second set of options for specifying a second set of values for a second set of attributes associated with the workspace.

3. The non-transitory machine-readable medium of claim 1, wherein determining the set of users associated with the workspace based on the set of values for the set of attributes comprises:
accessing a set of mappings, each mapping in the set of mappings specifying a user and values for a subset of the set of attributes; and
identifying users with values for the subset of the set of attributes that match the set of values for the set of attributes.

4. The non-transitory machine-readable medium of claim 3, wherein each mapping in the set of mappings further specifies a set of access control privileges for controlling access to the workspace by the user based on a status of the workspace, wherein the program further comprises a set of instructions for setting a status of the workspace to a first status.

5. The non-transitory machine-readable medium of claim 4, wherein the program further comprises sets of instructions for:
receiving an input from a user in the set of users; and
in response to receiving the input, setting the status of the workspace to a second status.

6. The non-transitory machine-readable medium of claim 3, wherein the subset of the set of attributes specified in each mapping in the set of mappings comprises one or more of a region attribute, a department attribute, and a commodity attribute.

7. The non-transitory machine-readable medium of claim 1, wherein the program further comprises providing a graphical user interface (GUI) comprising a set of user 2 interface (UI) controls for specifying the set of values for the set of attributes associated with 3 the workspace, wherein the set of values for the set of attributes associated with the workspace are received through the GUI.

8. A method comprising:
receiving a request to create a workspace in which users can collaborate and a set of values for a set of attributes associated with the workspace;
based on the set of values for the set of attributes, determining a set of users associated with the workspace;
assigning the set of users to the workspace; and
generating the workspace, the workspace comprising the set of values for the set of attributes and the set of users.

9. The method of claim 8, wherein the set of values for the set of attributes is a first set of values for a first set of attributes, the method further comprising:
providing a first set of options for specifying the first set of values for the first set of attributes associated with the workspace
upon receiving the first set of values for the first set of attributes associated with the workspace, providing a second set of options for specifying a second set of values for a second set of attributes associated with the workspace.

10. The method of claim 8, wherein determining the set of users associated with the workspace based on the set of values for the set of attributes comprises:
accessing a set of mappings, each mapping in the set of mappings specifying a user and values for a subset of the set of attributes; and
identifying users with values for the subset of the set of attributes that match the set of values for the set of attributes.

11. The method of claim 10, wherein each mapping in the set of mappings further specifies a set of access control privileges for controlling access to the workspace by the user based on a status of the workspace, the method further comprising setting a status of the workspace to a first status.

12. The method of claim 11 further comprising:
receiving an input from a user in the set of users; and
in response to receiving the input, setting the status of the workspace to a second status.

13. The method of claim 10, wherein the subset of the set of attributes specified in each mapping in the set of mappings comprises one or more of a region attribute, a department attribute, and a commodity attribute.

14. The method of claim 8 further comprising providing a graphical user interface (GUI) comprising a set of user interface (UI) controls for specifying the set of values for the set of attributes associated with the workspace, wherein the set of values for the set of attributes associated with the workspace are received through the GUI.

15. A system comprising:
a set of processing units; and
a non-transitory machine-readable medium storing instructions that when executed by at least one processing unit in the set of processing units cause the at least one processing unit to:
receive a request to create a workspace in which users can collaborate and a set of values for a set of attributes associated with the workspace;
based on the set of values for the set of attributes, determine a set of users associated with the workspace;
assign the set of users to the workspace; and
generate the workspace, the workspace comprising the set of values for the set of attributes and the set of users.

16. The system of claim 15, wherein the set of values for the set of attributes is a first set of values for a first set of attributes, wherein the instructions further cause the at least one processing unit to:
provide a first set of options for specifying the first set of values for the first set of attributes associated with the workspace
upon receiving the first set of values for the first set of attributes associated with the workspace, provide a second set of options for specifying a second set of values for a second set of attributes associated with the workspace.

17. The system of claim 15, wherein determining the set of users associated with the workspace based on the set of values for the set of attributes comprises:
accessing a set of mappings, each mapping in the set of mappings specifying a user and values for a subset of the set of attributes; and
identifying users with values for the subset of the set of attributes that match the set of values for the set of attributes.

18. The system of claim 17, wherein each mapping in the set of mappings further specifies a set of access control privileges for controlling access to the workspace by the user based on a status of the workspace, wherein the instructions further cause the at least one processing unit to set a status of the workspace to a first status.

19. The system of claim 18, wherein the instructions further cause the at least one processing unit to:
receive an input from a user in the set of users; and
in response to receiving the input, set the status of the workspace to a second status.

20. The system of claim 17, wherein the subset of the set of attributes specified in each mapping in the set of mappings comprises one or more of a region attribute, a department attribute, and a commodity attribute.
